(19) United States
(12) Patent Application Publication
(10) Pub. No.: US 2012/0062040 A1
(43) Pub. Date: Mar. 15, 2012

(54) SEMICONDUCTOR DEVICE AND SIGNAL TRANSMISSION METHOD

(76) Inventor: Shunichi Kaeriyama, Tokyo (JP)

(21) Appl. No.: 13/321,904

(22) PCT Filed: Apr. 22, 2010
(86) PCT No.: PCT/JP2010/002905

§ 371 Date: Nov. 22, 2011

(30) Foreign Application Priority Data
Jun. 4, 2009 (JP) 2009-135365

(51) Int. Cl. H01F 38/14

(52) U.S. Cl. 307/104

(57) ABSTRACT

A first inductor (310) and a second inductor (320) are formed in a multilayer interconnect layer (400), are wound in a plane parallel to a first substrate (102), and overlap each other. A first circuit (100) connects to either the first inductor (310) or the second inductor (320). At least a portion of the first circuit (100) is located inside the first inductor (310) and the second inductor (320) when seen in a plan view. The first circuit (100) includes a portion having any of a hook-shaped interconnect pattern, a slit-shaped interconnect pattern, and an interconnect pattern that functions as a resistive element or a capacitive element, and the portion is located inside the first inductor (310) and the second inductor (320) when seen in a plan view. In the present embodiment, a hook-shaped interconnect pattern is provided.

### TECHNICAL FIELD

The present invention relates to a semiconductor device and a signal transmission method which make it possible to transmit electrical signal between two circuits of which potentials of the electrical signals to be input are different from each other.

### BACKGROUND ART

Photo-couplers are often used when electrical signals having different potentials are input to two respective circuits, and the electrical signals are transmitted between the two circuits. The photo-couplers have a light-emitting element such as a light-emitting diode and a light receiving element such as a phototransistor, convert the input electrical signals into light by the light-emitting element, return the light to electrical signals by the light receiving element, and transmit the electrical signals.

The presence of the light-emitting element and the light receiving element in the photo-couplers, however, makes it difficult to reduce the size of the photo-couplers. In addition, the photo-couplers cannot follow an electrical signal having high frequency. As a technique for solving these problems, as disclosed in, for example, Patent Document 1, a technique for transmitting an electrical signal by inductively coupling two inductors is developed.

Patent Documents 2 and 3 disclose a technique in which a circuit is disposed inside an inductor used as an antenna, when seen in a plan view.

### Related Document

### Patent Document

[Patent Document 1] PCT Japanese Translation Patent Publication No. 2001-513276

[Patent Document 2] Japanese Unexamined Patent Publication No. 2008-283172

[Patent Document 3] International Publication No. 2004-112138

### DISCLOSURE OF THE INVENTION

When two inductors are provided in a semiconductor device so as to be inductively coupled to transmit an electrical signal, and circuits are integrated immediately below these two inductors, a magnetic field generated by the inductors generates induced electromotive force in the circuits, thus being capable of causing the circuit to malfunction.

The invention is to provide a semiconductor device and a signal transmission method capable of suppressing occurrence of malfunction in a circuit of a semiconductor device, when two inductors are provided in the semiconductor device so as to be inductively coupled to transmit an electrical signal.

### Means for Solving the Problems

According to the present invention, there is provided a semiconductor device comprising:
a first substrate;
a first circuit formed in the first substrate;
a multilayer interconnect layer formed over the first substrate;
a transmitting inductor formed in the multilayer interconnect layer and wound in a plane parallel to the first substrate; and
a receiving inductor formed in the multilayer interconnect layer and wound in a plane parallel to the first substrate, the receiving inductor overlapping with the transmitting inductor when seen in a plan view,
wherein the first circuit connects to either the transmitting inductor or the receiving inductor,
at least a portion of the first circuit is located inside the transmitting inductor and the receiving inductor when seen in a plan view, and
the first circuit includes a portion having any of a hook-shaped interconnect pattern, a slit-shaped interconnect pattern, and an interconnect pattern that functions as a resistive element or a capacitive element, the portion being located inside the transmitting inductor and the receiving inductor when seen in a plan view.

According to the present invention, there is provided a signal transmission method, in which a semiconductor device includes a first substrate; a first circuit formed in the first substrate; a multilayer interconnect layer formed over the first substrate; a transmitting inductor formed in the multilayer interconnect layer and wound in a plane parallel to the first substrate; and a receiving inductor formed in the multilayer interconnect layer and wound in a plane parallel to the first substrate, the receiving inductor overlapping with the transmitting inductor when seen in a plan view,
the method comprising:
connecting the first circuit to either the transmitting inductor or the receiving inductor;
causing at least a portion of the first circuit to be located inside the transmitting inductor and the receiving inductor in a plan view;
providing a portion of the first circuit with any of a hook-shaped interconnect pattern, a slit-shaped interconnect pattern, and an interconnect pattern that functions as a resistive element or a capacitive element, the portion being located inside the transmitting inductor and the receiving inductor when seen in a plan view; and
inputting a transmitting signal to the transmitting inductor and inductively coupling the transmitting inductor and the receiving inductor so as to transmit the transmitting signal to the receiving inductor.

### Advantage of the Invention

The present invention enables a magnetic field generated by an inductor to be prevented from causing a circuit to malfunction.

### BRIEF DESCRIPTION OF THE DRAWINGS

The above-mentioned objects, other objects, features and advantages will be made clearer from the preferred embodiments described below, and the following accompanying drawings.

FIG. 1 is a cross-sectional view illustrating the configuration of a semiconductor device according to a first embodiment.

FIG. 2 is a schematic plan view illustrating the semiconductor device shown in FIG. 1.

FIG. 3 is a schematic plan view illustrating the configuration of a semiconductor device according to a second embodiment.

FIG. 4 is a schematic plan view illustrating the configuration of a semiconductor device according to a third embodiment.

FIG. 5 is a schematic plan view illustrating the configuration of a semiconductor device according to a fourth embodiment.

FIG. 6 is a schematic plan view illustrating the configuration of a semiconductor device according to a fifth embodiment.

FIG. 7 is a cross-sectional view illustrating a semiconductor device according to a sixth embodiment.

FIG. 8 is a schematic plan view illustrating the configuration of a semiconductor device according to a seventh embodiment.

FIG. 9 is a cross-sectional view illustrating the configuration of a semiconductor device according to an eighth embodiment.

FIG. 10 is a plan view illustrating an example of an electromagnetic shielding interconnect pattern.

FIG. 11 is a cross-sectional view illustrating the configuration of a semiconductor device according to a ninth embodiment.

FIG. 12 is a diagram illustrating a state in which a transmitting driver circuit enables a current flowing to a first inductor to be controlled in any desired direction of a first direction or a second direction.

FIG. 13 is a cubic diagram more specifically illustrating the configuration of the semiconductor device shown in FIG. 3.

FIG. 14 is a diagram illustrating an example of an inverter circuit in the second embodiment.

FIG. 15 is a cubic diagram more specifically illustrating the configuration of the semiconductor device according to the second embodiment.

FIG. 16 is a first cubic diagram more specifically illustrating the configuration of the semiconductor. device according to the fifth embodiment.

FIG. 17 is a second cubic diagram more specifically illustrating the configuration of the semiconductor device according to the fifth embodiment.

FIG. 18 is a cubic diagram more specifically illustrating the configuration of the semiconductor device according to the seventh embodiment.

FIG. 19 is a diagram illustrating an example in which a MOS-type capacitive element of a filter circuit is formed of a polysilicon layer and a well layer, and a resistive element of the filter circuit is formed of a polysilicon layer.

FIG. 20 is a diagram illustrating an example in which the resistive element is formed of a well layer in the example shown in FIG. 19.

FIG. 21 is a cubic diagram more specifically illustrating the configuration of the semiconductor device according to the sixth embodiment.

### DESCRIPTION OF EMBODIMENTS

Hereinafter, the embodiment of the invention will be described with reference to the accompanying drawings. In all the drawings, like elements are referenced by like reference numerals and signs and descriptions thereof will not be repeated.

### First Embodiment

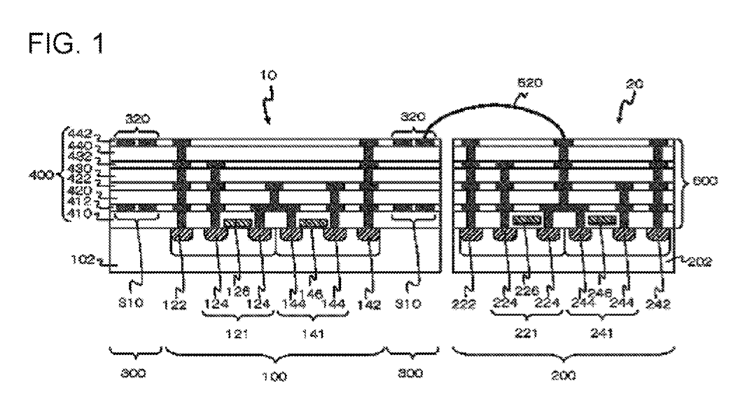

FIG. 1 is a cross-sectional view illustrating the configuration of a semiconductor device according to a first embodiment. The semiconductor device includes a first semiconductor chip 10. The first semiconductor chip 10 includes a first substrate 102, a first circuit 100, a multilayer interconnect layer 400, a first inductor 310 (transmitting inductor), and a second inductor 320 (receiving inductor). The first substrate 102 is a semiconductor substrate such as, for example, a silicon substrate. The first circuit 100 is formed in the first substrate 102. The multilayer interconnect layer 400 is formed on the first substrate 102. The first inductor 310 is formed in the multilayer interconnect layer 400, and is wound in a plane parallel to the first substrate 102. The second inductor 320 is formed in the multilayer interconnect layer 400, is wound in a plane parallel to the first substrate 102, and overlaps with the first inductor 310 when seen in a plan view. The first circuit 100 connects to either the first inductor 310 or the second inductor 320. When seen in a plan view, at least a portion of the first circuit 100 is located inside the first inductor 310 and the second inductor 320. A portion in the first circuit 100, being located inside the first inductor 310 and the second inductor 320 when seen in a plan view, is provided with any of a hook-shaped interconnect pattern, a slit-shaped interconnect pattern, and an interconnect pattern that functions as a resistive element or a capacitive element. In the embodiment, a hook-shaped interconnect pattern is provided.

The first inductor 310 and the second inductor 320 constitute a signal transmission element 300, and are inductively coupled with each other so as to mutually transmit an electrical signal. The electrical signal is, for example, a digital signal, but may be an analog signal.

In the embodiment, the first inductor 310 connects to the first circuit 100, and the second inductor 320 connects to a second semiconductor chip 20. The first circuit 100 is a transmitting circuit. That is, the first inductor 310 functions as a transmitting inductor, and the second inductor 320 functions as a receiving inductor. The second inductor 320 connects to the second semiconductor chip 20 through an interconnect, which is, for example, a bonding wire 520. The second semiconductor chip 20 includes a second substrate 202, a second circuit 200, and a multilayer interconnect layer 600. The second circuit 200 includes a receiving circuit, and connects, through the multilayer interconnect layer 600 and the bonding wire 520, to the second inductor 320.

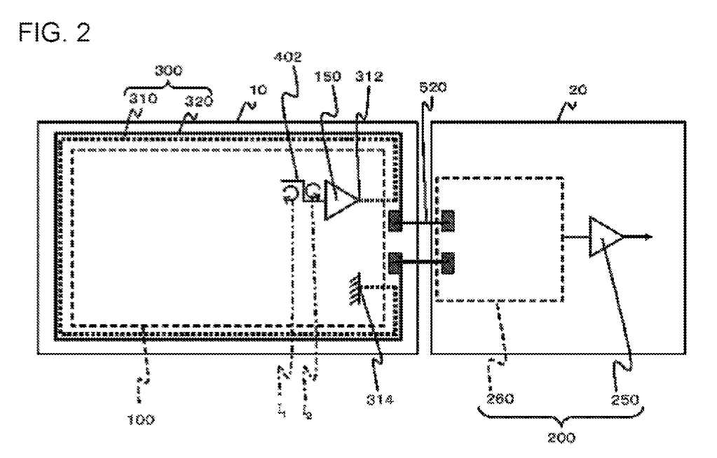

The first circuit 100 includes a modulation processing section that modulates a digital signal into a transmission signal, and a transmitting driver circuit that outputs the modulated signal to the first inductor 310. The second circuit 200 includes a receiving circuit 260 (shown in FIG. 2) connected to the second inductor 320, and a receiving driver circuit 250 (shown in FIG. 2). The receiving circuit 260 demodulates the modulated signal into a digital signal. The digital signal demodulated in the receiving circuit 260 is output to the receiving driver circuit 250. When the first circuit 100 has a loop-shaped interconnect pattern, the interconnect pattern has a diameter preferably equal to or less than one-tenth of the diameter of the first inductor 310 or the second inductor 320, so that the influence of a magnetic field by the first inductor 310 and the second inductor 320 is suppressed.

The respective electrical signals having different potentials are input to the first circuit 100 and the second circuit 200, but the first inductor 310 and the second inductor 320, being inductively coupled so as to transmit and receive the electrical signals, cause no problem to occur in the first circuit 100 and the second circuit 200. In the configuration of FIG. 1, as the case in which “the respective electrical signals having different potentials are input”, there are a case in which the amplitudes of the electrical signals (difference between the potential indicating 0 and the potential indicating 1) are different from each other, a case in which the reference potential (potential indicating 0) of the electrical signals is different, and a case in which the amplitudes of the electrical signals are different from each other and the reference potential of the electrical signals is different, and the like.

The first circuit 100 of the first semiconductor chip 10 includes a first transistor. There are a first conductivity-type transistor and a second conductivity-type transistor in the first transistor. A first conductivity-type first transistor 121 is formed in a second conductivity-type well, and includes two first conductivity-type impurity regions 124, serving as a source and a drain, and a gate electrode 126. A second conductivity-type first transistor 141 is formed in a first conductivity-type well, and includes two second conductivity-type impurity regions 144, serving as a source and a drain, and a gate electrode 146. A gate insulating film is located below each of the gate electrodes 126 and 146. These two gate insulating films are approximately equal to each other in thickness. The first transistors 121 and 141 constitute the above-mentioned transmitting driver circuit, for example, the inverter.

A second conductivity-type impurity region 122 is formed in the second conductivity-type well, and a first conductivity-type impurity region 142 is formed in the first conductivity-type well. The impurity region 122 connects to an interconnect for providing a reference potential (ground potential) of the first conductivity-type first transistor 121, and the impurity region 142 connects to an interconnect for providing a reference potential of the second conductivity-type first transistor 141.

The second circuit 200 of the second semiconductor chip 20 includes a second transistor. There are also the first conductivity-type transistor and the second conductivity-type transistor in the second transistor. A first conductivity-type second transistor 221 is formed in the second conductivity-type well, and includes two first conductivity-type impurity regions 224, serving as a source and a drain, and a gate electrode 226. A second conductivity-type second transistor 241 is formed in the first conductivity-type well, and includes two second conductivity-type impurity regions 244, serving as a source and a drain, and a gate electrode 246. A gate insulating film is located below each of the gate electrodes 226 and 246. The second transistor 221 and 241 constitute the above-mentioned receiving driver circuit 250, for example, the inverter.

A second conductivity-type impurity region 222 is formed in the first conductivity-type well, and a first conductivity-type impurity region 242 is formed in the second conductivity-type well. The impurity region 222 connects to an interconnect for providing a reference potential of the first conductivity-type second transistor 221, and the impurity region 242 connects to an interconnect for providing a reference potential of the second conductivity-type second transistor 241.

In the example shown in the drawing, the first transistors 121 and 141 and the second transistors 221 and 241 have thicknesses of the gate insulating films different from each other, but may have the same thickness.

In the embodiment, the first inductor 310 and the second inductor 320 are spiral-shaped interconnect patterns formed in the respective different interconnect layers. The first inductor 310 is located in, for example, a lowermost interconnect layer 412, and the second inductor 320 is located in, for example, an uppermost interconnect layer 442.

When seen in a plan view, the entire first circuit 100 is located inside the first inductor 310 and the second inductor 320. In addition, the distance between the first inductor 310 and the second inductor 320 is smaller than the diameter of the first inductor 310 and the diameter of the second inductor 320. This enables the first inductor 310 and the second inductor 320 to be easily inductively coupled to each other.

The multilayer interconnect layer 400 is a layer in which an insulating layer and an interconnect layer are alternately laminated in this order t times (t≧3) or more. The first inductor 310 is provided in an n-th interconnect layer of the multilayer interconnect layer 400. The second inductor 320 is provided in an m-th interconnect layer (t≧m≧n+2) of the multilayer interconnect layer, thus being located above the first inductor 310. That is, the first inductor 310 and the second inductor 320 is formed in the respective different interconnect layers. An inductor located above the first inductor 310 is not provided in any of the interconnect layers located between the n-th interconnect layer and the m-th interconnect layer. In the embodiment, the multilayer interconnect layer 400 includes a configuration in which an insulating layer 410, the interconnect layer 412, an insulating layer 420, an interconnect layer 422, an insulating layer 430, an interconnect layer 432, an insulating layer 440, and an interconnect layer 442 overlap one another in this order. The insulating layers 410, 420, 430, and 440 may be a structure in which a plurality of insulating films is laminated, and may be one insulating film.

The interconnects located in the interconnect layers 412, 422, 432, and 442 are a Cu interconnect formed by a damascene method, and are buried in grooves formed in the interconnect layers 412, 422, 432, and 442, respectively. A pad (not shown) is formed in an uppermost interconnect. At least one of the above-mentioned interconnect layers 412, 422, 432, and 442 may be an Al alloy interconnect. The interconnects formed in the interconnect layers 412, 422, 432, and 442 connect to each other through plugs buried in the insulating layers 410, 420, 430, and 440.

Each of the insulating films constituting the insulating layer and the interconnect layer may be a SiO₂ film, and may be a low-dielectric-constant film. A low-dielectric-constant film may be formed of an insulating film having, for example, a relative dielectric constant of 3.3 or less, preferably 2.9 or less. A low-dielectric-constant film may be SiOC, and further may be poly hydrogen siloxane such as hydrogen silsesquioxane (HSQ), methylsilsesquioxane (MSQ), or methyl hydrogen silsesquioxane (MHSQ); aromatic-containing organic materials such as polyarylether (PAE), divinyl-siloxane-bis-benzocyclobutene (BCB), or Silk (registered trademark); SOG; FOX (flowable oxide); CYTOP; bensocyclobutene (BCB); or the like. A low-dielectric-constant film may be also a porous film of them.

FIG. 2 is a schematic plan view of the semiconductor device shown in FIG. 1. As mentioned above, the first circuit 100 is located inside the first inductor 310 and the second inductor 320. The first circuit 100 includes a transmitting driver circuit 150. As mentioned above, at least a portion of the transmitting driver circuit 150, for example, the inverter is constituted by the first transistors 121 and 141. The transmitting driver circuit 150 connects to at least one end 312 of the first inductor 310. The other end 314 of the first inductor 310 is grounded in the example shown in the drawing.

The first circuit 100 includes a portion having a hook-shaped interconnect pattern 402, and the portion is located inside the first inductor 310 and the second inductor 320 when seen in a plan view.

Next, a method of manufacturing the first semiconductor chip 10 will be described. First, the first circuit 100 is formed in the first substrate 102. Next, the multilayer interconnect layer 400 is formed on the first substrate 102. When the multilayer interconnect layer 400 is formed, the first inductor 310 and the second inductor 320 are formed. The first inductor 310 connects to the first circuit 100 through the interconnect provided within the multilayer interconnect layer 400.

Next, an operation and an effect of the embodiment will be described. In the embodiment, at least a portion of the first circuit 100 is located inside the first inductor 310 and the second inductor 320 when seen in a plan view. In such a case, a magnetic field generated by the first inductor 310 may cause noise to be generated in the first circuit 100. On the other hand, in the embodiment, the hook-shaped interconnect pattern 402 is provided in the interconnect within the first circuit 100, as shown in FIG. 2. The magnetic field generated by the first inductor 310 causes a first eddy current I₁ and a second eddy current I₂ to be generated in the hook-shaped interconnect pattern 902. The direction of the second eddy current I₂ being generated is reverse to that of the first eddy current I₁. This prevents noise or malfunction from occurring in the first circuit 100.

### Second Embodiment

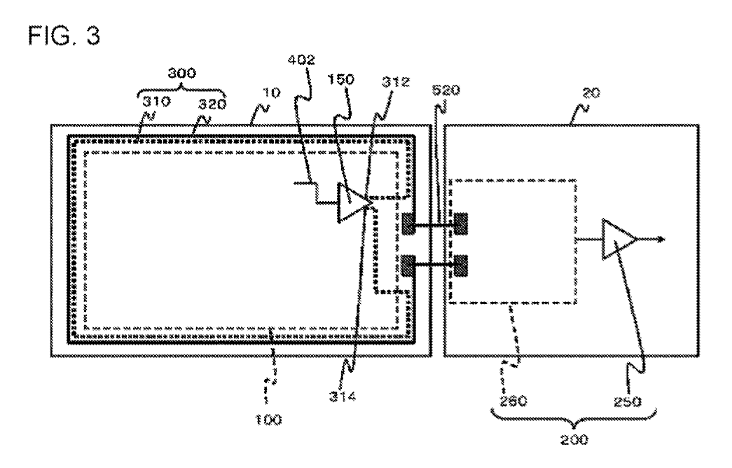

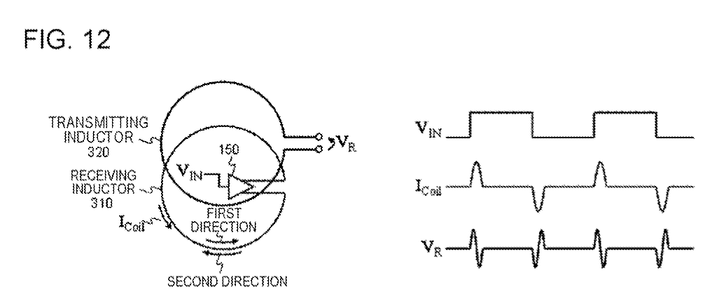

FIG. 3 is a schematic plan view illustrating the configuration of a semiconductor device according to a second embodiment, and is a diagram equivalent to FIG. 2 in the first embodiment. The semiconductor device has the same configuration as that of the first embodiment, except that both ends of the first inductor 310 connect to the transmitting driver circuit 150. In the embodiment, as shown in FIG. 12, the transmitting driver circuit 150 enables the current flowing to the first inductor 310 to be controlled in any desired direction of the first direction or the second direction. This enables the direction of electromotive force generated in the second inductor 320 to be reversed. When the transmitting driver circuit 150 is controlled by the first circuit 100, the direction of the current flowing to the first inductor 310 can be changed depending on a value of a logic signal to be input to the first circuit 100, thus a circuit connected to the second inductor can determine the value of the logic signal input to the first circuit 100.

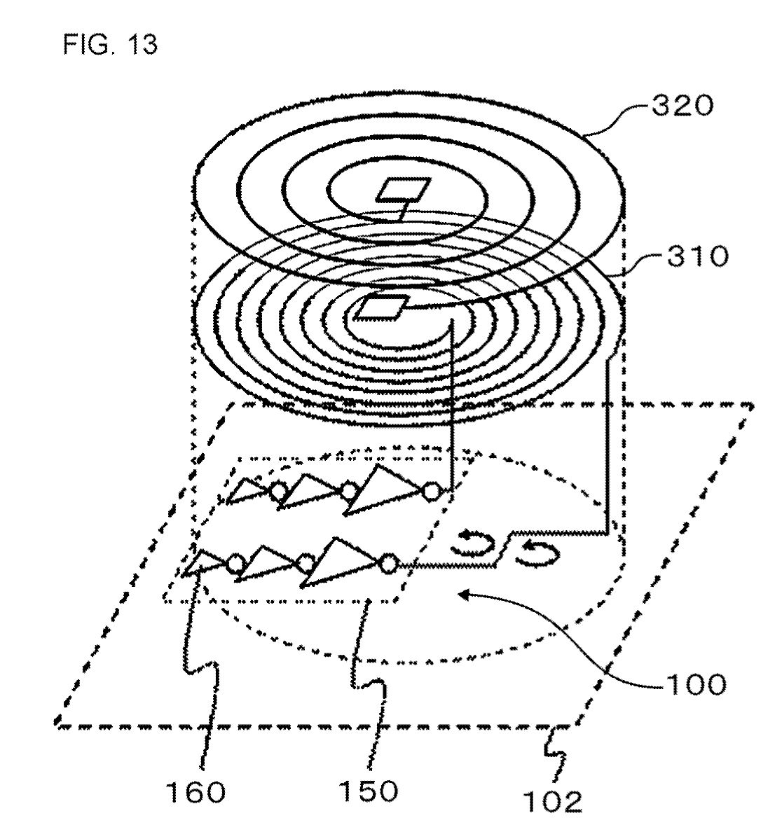

FIG. 13 is a cubic diagram more specifically illustrating the configuration of the semiconductor device shown in FIG. 3. In the semiconductor device, the first circuit 100 is mounted in the first substrate 102. The first circuit 100 includes a transmitting driver circuit 150 including an inverter circuit 160. The first inductor 310 and the second inductor 320 are mounted on the inverter circuit 160.

Since a large current flows in the transmitting inductor of the first inductor 310 and the second inductor 320, the inverter circuit 160 of the transmitting driver circuit 150 occupies a large area. Yet, the deposition of the large inverter circuit 160 below the inductor allows the area of the first substrate 102 to be used more effectively use. This allows the cost of the semiconductor device to be reduced.

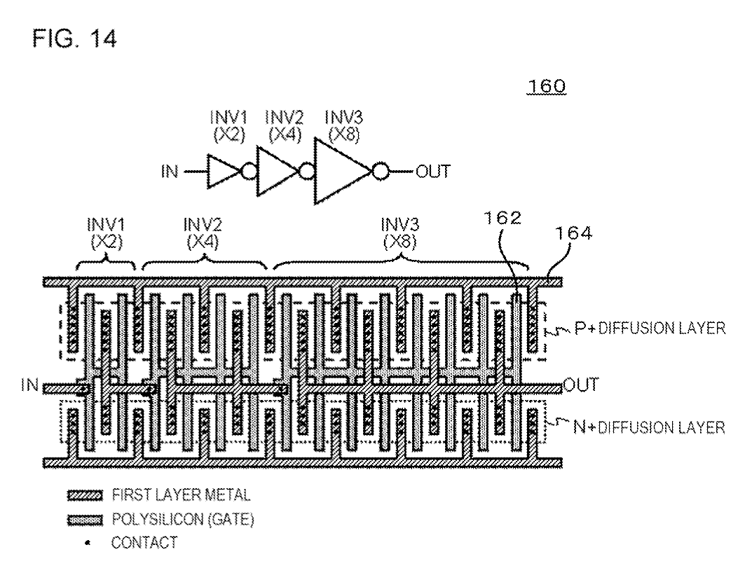

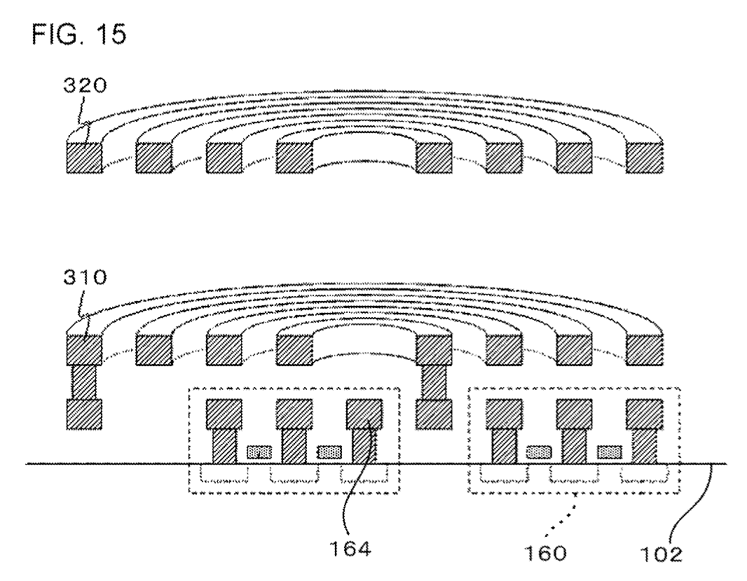

The inverter circuit 160 can be constituted by a transistor, a polysilicon interconnect 162, and an interconnect 164 made of a first layer metal which are formed in the first substrate 102, for example, as shown in FIG. 14. Accordingly, integration of the inductor on the inverter circuit 160 enables the interconnect layer above a second layer metal to be used in the formation of the inductor, as shown in FIG. 15. In order that a dielectric strength voltage is secured between the transmitting inductor and the receiving inductor, that is, between the first inductor 310 and the second inductor 320, the distance between them is preferably maintained. For this reason, a lower-layer metal such as a second layer metal can be preferably used in the formation of the second inductor 320 in order that the dielectric strength voltage is secured. Accordingly, the inverter circuit 160 is a circuit suitable for being displaced below the first inductor 310 and the second inductor 320.

The inverter circuit 160, not including a large loop-shaped interconnect pattern as shown in FIG. 14, hardly generates noise by the induced electromotive force even when the inverter circuit is formed below the first inductor 310 and the second inductor 320. Accordingly, the inverter circuit is a circuit suitable for being displaced below the first inductor 310 and the second inductor 320.

Even in the embodiment, the hook-shaped interconnect pattern 402 is included, and thus it is possible to obtain the same effect as that of the first embodiment. In addition, as mentioned above, although the inverter circuit 160 has a large area, formation of the inverter circuit 160 below the first inductor 310 and the second inductor 320 can prevent the size of the semiconductor device from increasing.

### Third Embodiment

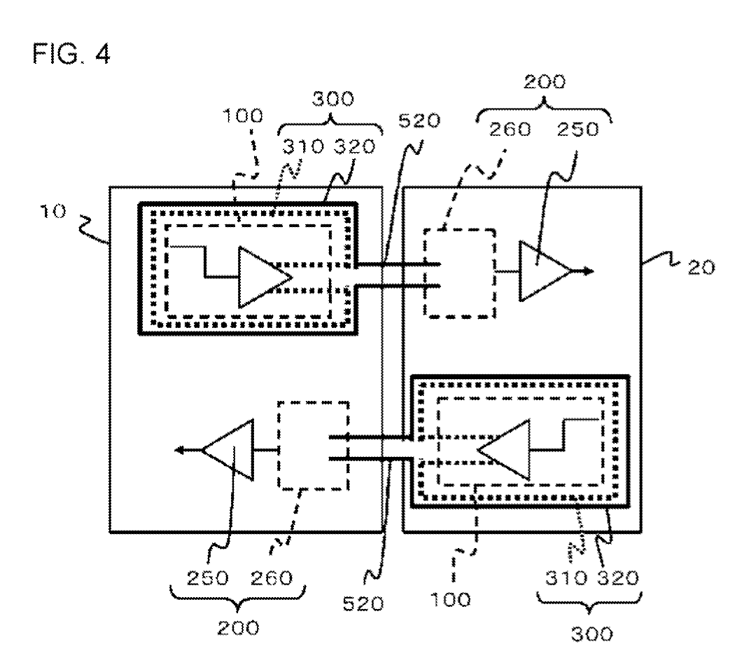

FIG. 4 is a schematic plan view illustrating the configuration of a semiconductor device according to a third embodiment. The semiconductor device has the same configuration as that of the first or second embodiment, except that the first semiconductor chip 10 and the second semiconductor chip 20 transmit and receive signals bi-directionally, and include the first circuit 100, the first inductor 310, the second inductor 320, and the second circuit 200.

That is, the first circuit 100 of the first semiconductor chip 10 connects to the second circuit 200 of the second semiconductor chip 20 through the first inductor 310, the second inductor 320, and the bonding wire 520, of the first semiconductor chip 10. In addition, the first circuit 100 of the second semiconductor chip 20 connects to the second circuit 200 of the first semiconductor chip 10 through the first inductor 310, the second inductor 320, and the bonding wire 520, of the second semiconductor chip 20.

Even in the embodiment, it is possible to obtain the same effect as that of the first or second embodiment.

### Fourth Embodiment

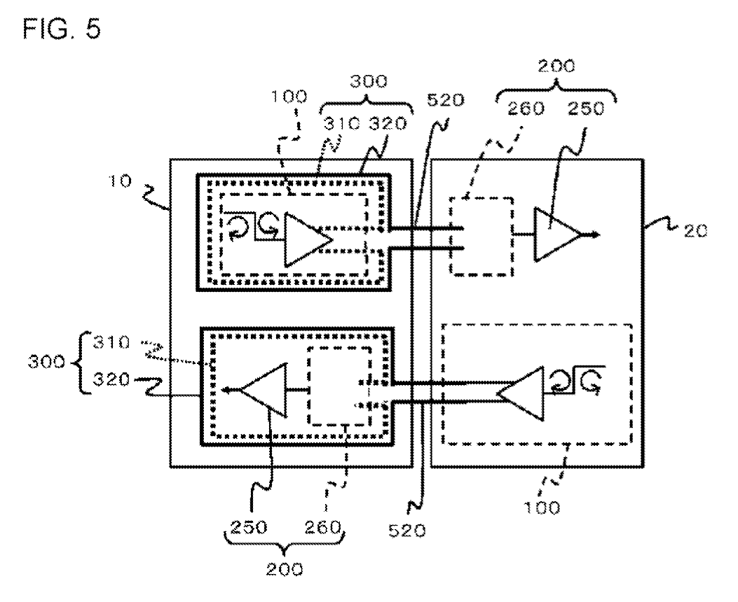

FIG. 5 is a schematic plan view illustrating the configuration of a semiconductor device according to a fourth embodiment. The semiconductor device has the same configuration as that of the third embodiment, except that two pairs of the first inductor 310 and the second inductor 320 are formed in the first semiconductor chip 10.

The first inductor 310 serving as a receiving inductor connects to the second circuit 200 of the first semiconductor chip 10. At least a portion of the second circuit 200, preferably the entirety of the second circuit 200, is located inside the first inductor 310 and the second inductor 320 inductively coupled to the first inductor 310.

Even in the embodiment, it is possible to obtain the same effect as that of the third embodiment.

### Fifth Embodiment

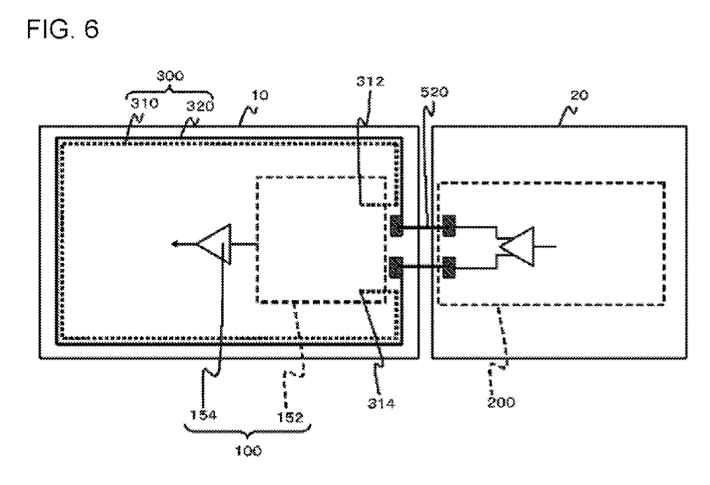

FIG. 6 is a schematic plan view illustrating the configuration of a semiconductor device according to a fifth embodiment, and is a diagram equivalent to FIG. 2 in the first embodiment. The semiconductor device has the same configuration as that of the semiconductor device according to the first embodiment, except that the first circuit 100 includes a receiving circuit 152 and a receiving driver circuit 154, and the second circuit 200 is a transmitting circuit. In the embodiment, the second inductor 320 functions as a transmitting inductor, and the first inductor 310 functions as a receiving inductor.

The second circuit 200 includes a modulation processing section that modulates a digital signal into a transmission signal, and a transmitting driver circuit that outputs the modulated signal to the second inductor 320. The receiving circuit 152 of the first circuit 100 demodulates the modulated signal into a digital signal. The digital signal demodulated in the receiving circuit 152 is output to the receiving driver circuit 154.

The receiving driver circuit 154 includes the first transistors 121 and 141 shown in FIG. 1 of the first embodiment. The first transistors 121 and 141 constitute an inverter. The receiving driver circuit 154, driving elements outside the chip such as a power transistor, has preferably an output current or a sink current equal to or more than 100 mA, and an on-resistance equal to or less than 100 Ω.

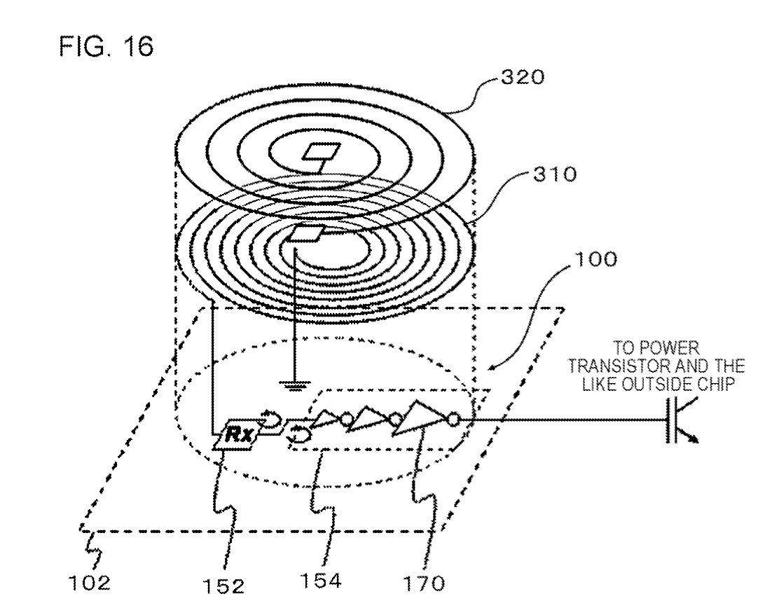

FIG. 16 is a first cubic diagram more specifically illustrating the configuration of the semiconductor device according to the fifth embodiment. In this semiconductor device, the first circuit 100 is mounted in the first substrate 102. The first circuit 100 is the receiving driver circuit 154 including an inverter circuit 170. The first inductor 310 and the second inductor 320 are mounted on the inverter circuit 170.

The output of the receiving driver circuit 154 connects to a power transistor and the like located outside the first substrate 102. Since a large current is required for driving the power transistor, the inverter circuit of the receiving driver circuit 154 occupies a large area. Generally, the receiving driver circuit 154 preferably has a current drive capability equal to or more than 100 mA, and the on-resistance of a final-stage inverter is preferably equal to or less than 100 Ω.

In the second embodiment, the disposition of the large inverter circuit 170 below the first inductor 310 and the second inductor 320, as described in FIGS. 13 to 15, allows the cost to be reduced. The inverter circuit 170, having an advantage of not easily influenced by noise due to the induced electromotive force while having an advantage of realizing a high breakdown voltage, is a circuit suitable for being displaced below the first inductor 310 and the second inductor 320.

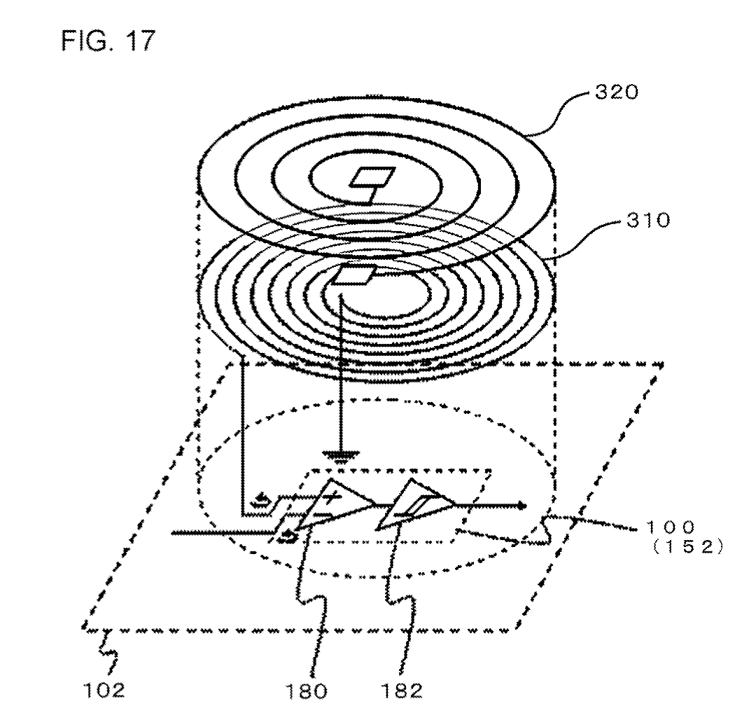

FIG. 17 is a second cubic diagram more specifically illustrating the configuration of the semiconductor device according to the fifth embodiment. In the semiconductor device, the first circuit 100 is mounted in the first substrate 102. The first circuit 100 is the receiving circuit 152 including at least one of an amplifier circuit 180, a comparator, and a hysteresis amplifier 182. The first inductor 310 and the second inductor 320 are mounted on the receiving circuit 152.

Since the amplifier circuit 180, the comparator, and the hysteresis amplifier 182 can be generally constituted by the polysilicon layer and the interconnect reaching the first layer metal or the second layer metal, the interconnect layer above the second layer metal or a third layer metal is used in the first inductor 310 and the second inductor 320. In addition, since the amplifier circuit 180, the comparator, and the hysteresis amplifier 182 can generally operate at a small current of approximately 1 mA or less, the size of the circuit can be reduced. Accordingly, the absence of a large loop-shaped interconnect pattern in the amplifier circuit 180, the comparator, and the hysteresis amplifier 182, prevents the induced electromotive force from generating noise even when they are formed below the inductor.

Even in the embodiment, it is possible to obtain the same effect as that of the first embodiment.

### Sixth Embodiment

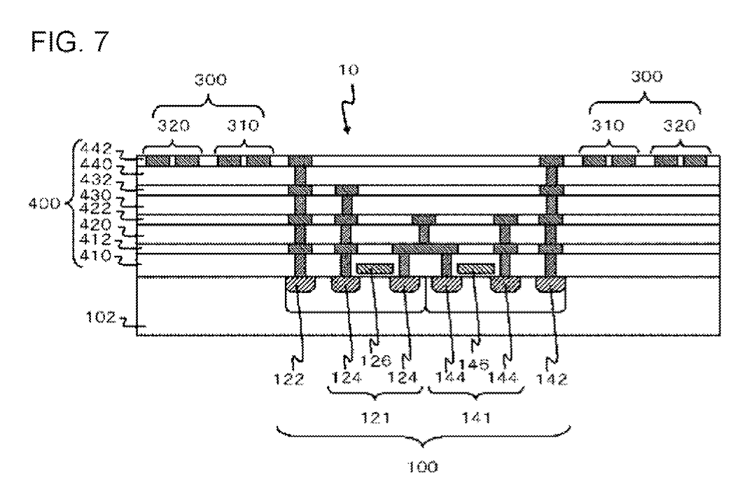

FIG. 7 is a cross-sectional view illustrating the configuration of a semiconductor device according to a sixth embodiment, and is equivalent to the diagram in which the second semiconductor chip 20 is not shown in FIG. 1 of the first embodiment. The semiconductor device has the same configuration as that of the semiconductor device shown in any of the first to fifth embodiments, except that the first inductor 310 and second inductor 320 are formed in the same interconnect layer, and one of them is located inside the other.

In the example shown in the drawing, the first inductor 310 and the second inductor 320 are formed in the uppermost interconnect layer 442, but may be formed in another interconnect layer. When seen in a plan view, although the first inductor 310 is located inside the second inductor 320, the second inductor 320 may be located inside the first inductor 310.

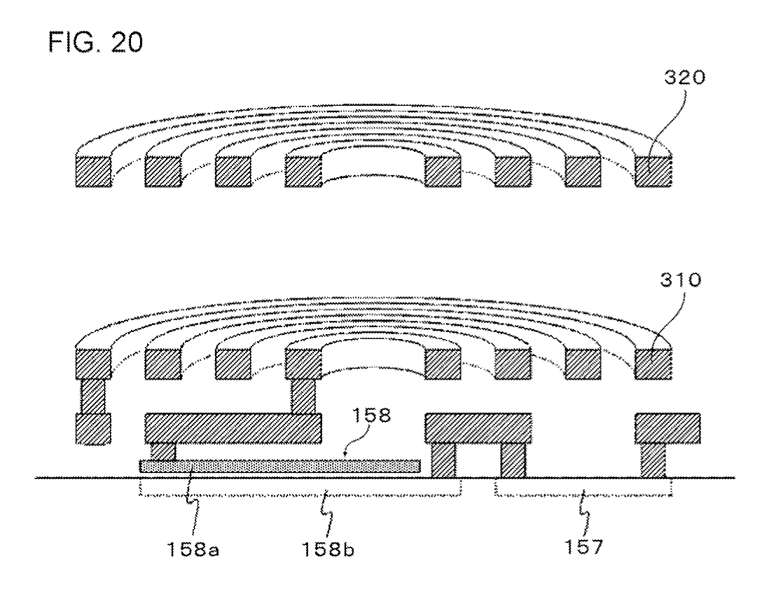

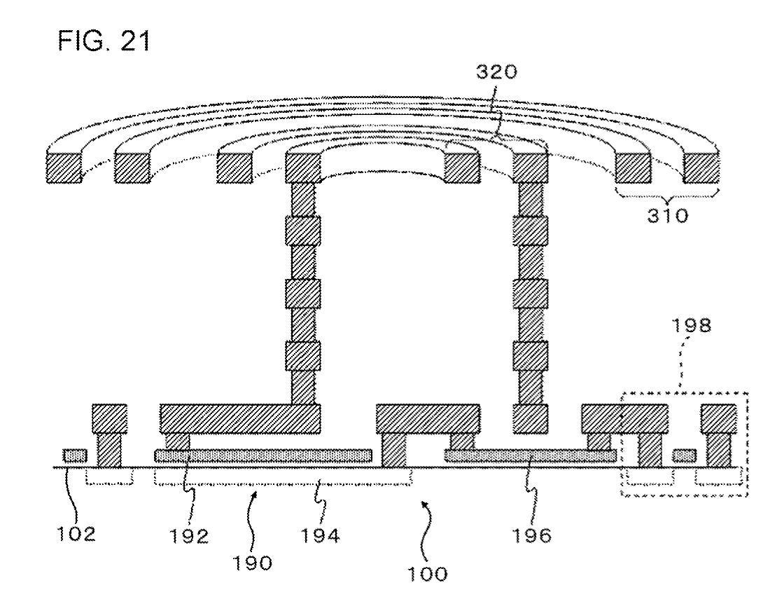

FIG. 21 is a cubic diagram more specifically illustrating the configuration of the semiconductor device according to the sixth embodiment. In the semiconductor device, the first circuit 100 is mounted in the first substrate 102. The first inductor 310 and the second inductor 320 are mounted on the first circuit 100. Since the first inductor 310 and the second inductor 320 are formed in the same interconnect layer, it is not necessary to dispose an inductor in the second layer metal. The dielectric strength voltage between the transmitting driver circuit and the receiving circuit becomes, in the examples until FIG. 20, a dielectric strength voltage between the second layer metal and the N-th layer metal because the inductor is formed in the second layer metal, but in the embodiment, it becomes a dielectric strength voltage between the first layer metal and the N-th layer metal (N=5 in FIG. 21). For this reason, the dielectric strength voltage can be made higher than those of the examples until FIG. 20. Alternatively, the number of the interconnect layers can be reduced so that the dielectric strength voltage is maintained and the cost is reduced, because it is possible to secure the same dielectric strength voltage as those of the examples until FIG. 20 even when the number of upper interconnect layers is made smaller by one than those of examples until FIG. 20.

A MOS-type capacitive element 190 is formed in the first substrate 102. One end of the second inductor 320 connects to a gate electrode 192 of the capacitive element 190, and the other end of the second inductor 320 connects to a polysilicon resistor 196. One end of the polysilicon resistor 196 connects to a diffusion layer 194 of the capacitive element 190 through an interconnect and a contact. The other end of the polysilicon resistor 196 connects to a transistor 198.

Even in the embodiment, it is possible to obtain the same effect as those of the first to fifth embodiments. In addition, change of the interconnect pattern of the interconnect layer including the first inductor 310 and the second inductor 320 results in changing the mutual distance between the first inductor 310 and the second inductor 320, thereby allowing a withstanding voltage between the first inductor 310 and the second inductor 320 to be changed. For this reason, the withstanding voltage between the first inductor 310 and the second inductor 320 can be easily changed.

### Seventh Embodiment

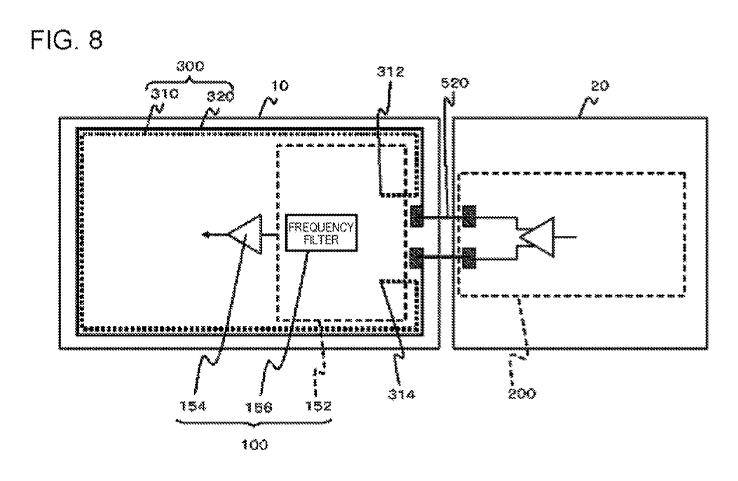

FIG. 8 is a schematic plan view illustrating the configuration of a semiconductor device according to a seventh embodiment, and is a diagram equivalent to FIG. 6 in the fifth embodiment. The semiconductor device has the same configuration as that of the semiconductor device according to the fifth embodiment, except that the receiving circuit 152 includes a filter circuit 156, and that the first inductor 310 and the second inductor 320 are formed in the same interconnect layer like the sixth embodiment. The filter circuit 156 is constituted by a resistor and a capacitor. The resistor and the capacitor are formed in, for example, the interconnect layer located below the first inductor 310 and the second inductor 320.

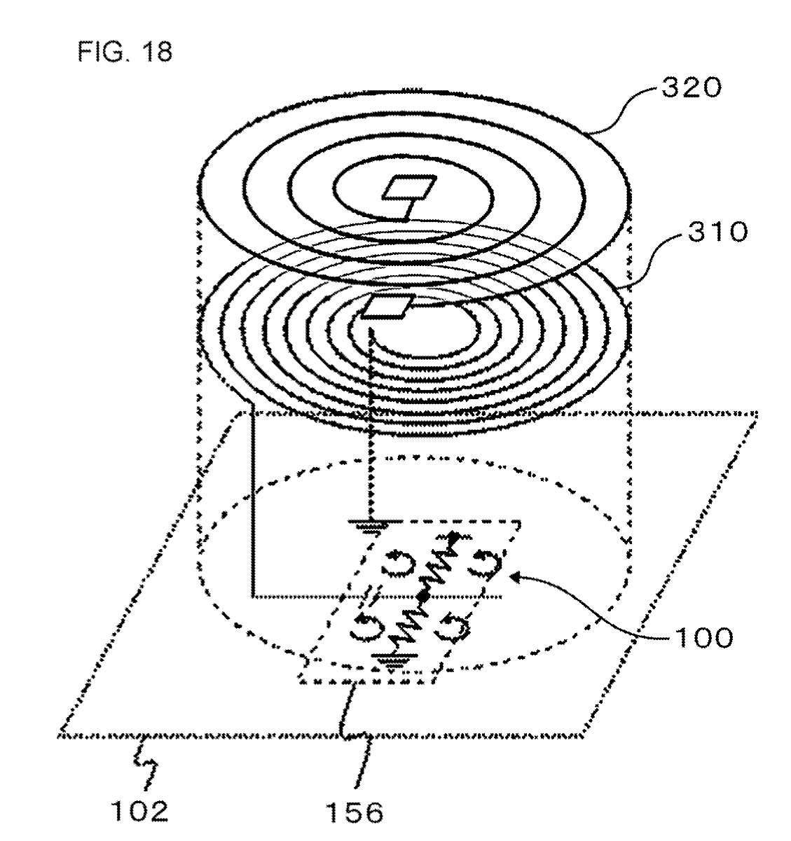

FIG. 18 is a cubic diagram more specifically illustrating the configuration of the semiconductor device according to the seventh embodiment. In the semiconductor device, the first circuit 100 is mounted in the first substrate 102. The first circuit 100 is the filter circuit 156 including either a resistive element or a capacitive element. The first inductor 310 and the second inductor 320 are mounted on the filter circuit 156.

Since the resistive element or the capacitive element can be generally constituted by a combination of the well layer, the diffusion layer, the polysilicon layer, and the first layer metal, the interconnect layer above the second layer metal is used in the inductor. Absence of the need for a large loop-shaped interconnect pattern to constitute the resistive element or the capacitive element, prevents the induced electromotive force from, generating noise even when they are formed below the first inductor 310 and the second inductor 320. Accordingly, the resistive element, the capacitive element, and the filter circuit 156 with a combination of them are circuits suitable for being displayed below the first inductor 310 and the second inductor 320.

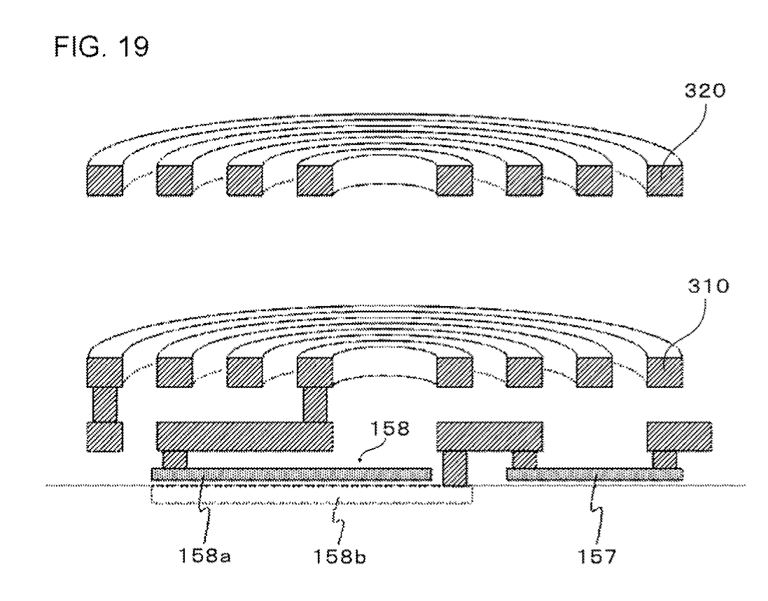

FIG. 19 is a diagram illustrating an example in which a MOS-type capacitive element 158 of the filter circuit 156 is formed of a polysilicon layer and a well layer, and a resistive element 157 of the filter circuit 156 is formed of a polysilicon layer. FIG. 20 is a diagram illustrating an example in which the resistive element 157 is formed of a well layer. One end of the second inductor 320 connects to a gate electrode 158a of the capacitive element 158. One end of the polysilicon resistor 196 connects to a diffusion layer 158b of the capacitive element 158 through an interconnect and a contact, of the first layer metal. In addition to the example shown herein, the capacitive element may be formed of a two-layer polysilicon layer, and may also be formed of a Metal-Insulator-Metal (MIM) capacitor in which the first layer metal is disposed in a comb shape, or a parallel plate type MIM capacitor in which the first layer metal and the second layer metal are parallel disposed. In addition, the resistive element may be formed of a diffusion layer, and may also be formed of a metal layer.

In the examples shown in FIGS. 19 and 20, the first layer metal is used as a leading line of the first inductor 310, a leading line of resistive element 157, and a leading line of the capacitive element 158 which are formed of the second layer metal. The metal layer above the second layer metal can be used for forming the first inductor 310 and the second inductor 320. Generally, the resistive element or the capacitive element occupies a larger area than that of a transistor. Accordingly, disposition of such an element below the first inductor 310 and the second inductor 320 allows the area of the first substrate 102 to be used more effectively, thus enabling the cost of the semiconductor device to be reduced.

In order that a dielectric strength voltage is secured between the transmitting inductor and the receiving inductor, the distance between them is preferably maintained. For this reason, a lower-layer metal such as the second layer metal can be preferably used in the formation of the first inductor 310 in order that the dielectric strength voltage is secured. Accordingly, the capacitive element 158, the resistive element 157, and the filter circuit 156 making use of them are circuits suitable for being displayed below the first inductor 310 and the second inductor 320.

Even in the embodiment, it is possible to obtain the same effect as that of the fifth embodiment. In addition, formation of the first inductor 310 and the second inductor 320 in the same interconnect layer facilitates securing of the interconnect layer for forming a resistor and a capacitor which constitute the filter circuit 156. This effect becomes particularly conspicuous in the case where the first inductor 310 and the second inductor 320 are formed in the uppermost interconnect layer. In this case, since the resistor and the capacitor that constitute the filter circuit 156 can be formed in a layer located below the second-layer interconnect layer 422, it is also possible to secure a withstanding voltage of the filter circuit 156 and the second inductor 320.

### Eighth Embodiment

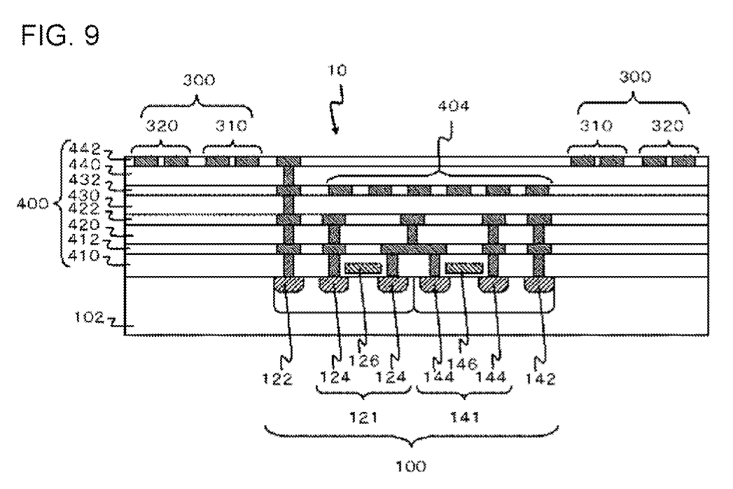

FIG. 9 is a cross-sectional view illustrating the configuration of a semiconductor device according to an eighth embodiment, and is a diagram equivalent to FIG. 7 in the sixth embodiment. The semiconductor device has the same configuration as that of the semiconductor device according to the sixth embodiment, except that there is an electromagnetic shielding interconnect pattern 404 which is a slit-shaped interconnect pattern.

The electromagnetic shielding interconnect pattern 404 is formed in the interconnect layer 432 located between the first inductor 310/the second inductor 320 and the first substrate 102. The electromagnetic shielding interconnect pattern 404 overlaps with the first circuit 100 when seen in a plan view, and is grounded.

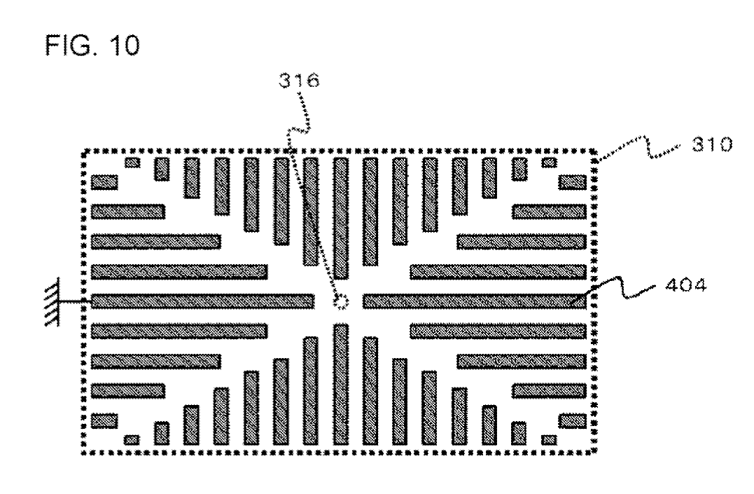

FIG. 10 is a plan view illustrating an example of the electromagnetic shielding interconnect pattern 404. In the semiconductor device, the first inductor 310 has a center overlapping with that of the second inductor 320. The electromagnetic shielding interconnect pattern 404 is formed so as to radially extend from the center 316 of the first inductor 310 and the second inductor 320.

Even in the embodiment, it is possible to obtain the same effect as that of the seventh embodiment. In addition, the provision of the electromagnetic shielding interconnect pattern 404 can prevent a magnetic flux occurring in the first inductor 310 and the second inductor 320 from generating noise in the first circuit 100.

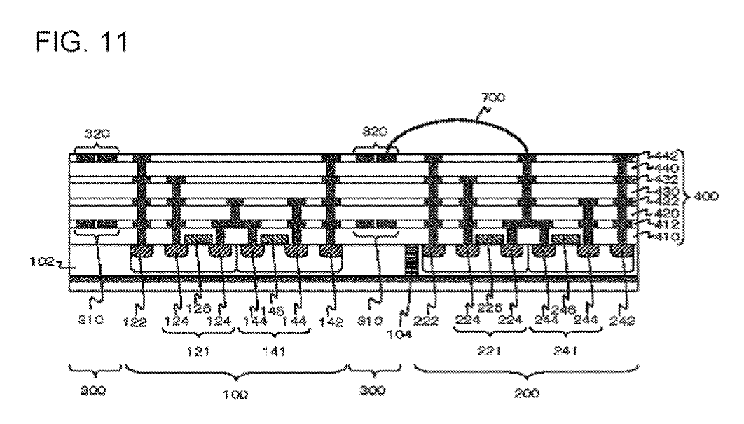

FIG. 11 is a cross-sectional view illustrating the configuration of a semiconductor device according to a ninth embodiment. The semiconductor device has the same configuration as that of the semiconductor device according to any of the first to eighth embodiments, except that the first substrate 102 is a silicon-on-insulator (SOI) substrate, and that the second circuit 200 is formed in the first substrate 102. That is, the semiconductor device is formed divided into two semiconductor chips in the first to eighth embodiments, but in the embodiment, the semiconductor device is formed in one semiconductor chip. The second inductor 320 and the second circuit 200 connect to each other through, for example, a bonding wire 700.

An element isolation film 104 is buried in a silicon layer of the first substrate 102. The element isolation film 104 has a lower end reaching the insulating layer of the first substrate 102. The element isolation film 104 insulates the first circuit 100 and the second circuit 200 from each other. For this reason, even when the first circuit 100 has a reference voltage different from that of the second circuit 200, the first circuit 100 and the second circuit 200 are prevented from mutually influence each other.

Even in the embodiment, it is possible to obtain the same effect as those of the first to eighth embodiments. In addition, it is possible to form the first circuit 100 and the second circuit 200 in one semiconductor chip.

As described above, although the embodiments of the invention have been set forth with reference to the drawings, it is merely illustrative of the invention, and various configurations other than those stated above can be adopted.

Priority is claimed on Japanese Patent Application No. 2009-135365, filed on Jun. 4, 2009, the content of which is incorporated herein by reference.

1. A semiconductor device comprising:
a first substrate;
a first circuit formed in the first substrate;
a multilayer interconnect layer formed over the first substrate;
a transmitting inductor formed in the multilayer interconnect layer and wound in a plane parallel to the first substrate; and
a receiving inductor formed in the multilayer interconnect layer and wound in a plane parallel to the first substrate, the receiving inductor overlapping with the transmitting inductor when seen in a plan view,
wherein the first circuit connects to either the transmitting inductor or the receiving inductor,
at least a portion of the first circuit is located inside the transmitting inductor and the receiving inductor when seen in a plan view, and
the first circuit includes a portion having any of a hook-shaped interconnect pattern, a slit-shaped interconnect pattern, and an interconnect pattern that functions as a resistive element or a capacitive element, the portion being located inside the transmitting inductor and the receiving inductor when seen in a plan view.

2. The semiconductor device according to claim 1, wherein the first circuit is a transmitting circuit, and includes a transmitting driver circuit connected to the transmitting inductor, and
the transmitting inductor has both ends connected to the transmitting driver circuit.

3. The semiconductor device according to claim 1, wherein the first circuit is a receiving circuit, and includes any of an amplifier circuit, comparator, and a hysteresis circuit, connected to the receiving inductor.

4. The semiconductor device according to claim 1, wherein the first circuit is a driver circuit,
the driver circuit has an output terminal connected to an external terminal, and
the driver circuit has an output current or a sink current equal to or more than 100 mA.

5. The semiconductor device according to claim 1, wherein the first circuit is a driver circuit,
the driver circuit has an output terminal connected to an external terminal, and
the driver circuit has an on-resistance equal to or less than 100 Ω.

6. The semiconductor device according to claim 1, wherein the first circuit is a filter circuit.

7. The semiconductor device according to claim 6, wherein the filter circuit includes a resistive element made of polysilicon or a capacitive element.

8. The semiconductor device according to claim 6, wherein the filter circuit includes a resistive element or a capacitive element, having a well layer or a diffusion layer.

9. The semiconductor device according to claim 1, wherein the first circuit is an inverter circuit.

10. The semiconductor device according to claim 1, further comprising an electromagnetic shielding interconnect pattern formed in an interconnect layer, the interconnect layer being located between the transmitting inductor/the receiving inductor and the first substrate, the electromagnetic shielding interconnect pattern overlapping with the first circuit when seen in a plan view, and being grounded.

11. The semiconductor device according to claim 10, wherein the centers of the transmitting inductor and the receiving inductor overlap each other, and
the electromagnetic shielding interconnect pattern is formed so as to radially extend from the vicinity of the center of the transmitting inductor and the receiving inductor.

12. The semiconductor device according to claim 1, wherein the first circuit includes a loop-shaped interconnect pattern, and
the loop-shaped interconnect pattern has a diameter equal to or less than one-tenth of that of the transmitting inductor or of the receiving inductor.

13. The semiconductor device according to claim 1, wherein the first circuit is composed of the first substrate and only an interconnect layer lowermost in the multilayer interconnect layer, the multilayer interconnect layer being formed over the first substrate.

14. The semiconductor device according to claim 13, wherein either the transmitting inductor or the receiving inductor connects to the first circuit, and is formed in an interconnect layer of the multilayer interconnect layer formed over the first substrate, and the interconnect layer is higher by one layer than a layer lowermost in the multilayer interconnect layer.

15. A signal transmission method, in which a semiconductor device includes a first substrate; a first circuit formed in the first substrate; a multilayer interconnect layer formed over the first substrate; a transmitting inductor formed in the multilayer interconnect layer and wound in a plane parallel to the first substrate; and a receiving inductor formed in the multilayer interconnect layer and wound in a plane parallel to the first substrate, the receiving inductor overlapping with the transmitting inductor when seen in a plan view,
the method comprising:
connecting the first circuit to either the transmitting inductor or the receiving inductor;
causing at least a portion of the first circuit to be located inside the transmitting inductor and the receiving inductor in a plan view;
providing a portion of the first circuit with any of a hook-shaped interconnect pattern, a slit-shaped interconnect pattern, and an interconnect pattern that functions as a resistive element or a capacitive element, the portion being located inside the transmitting inductor and the receiving inductor when seen in a plan view; and
inputting a transmitting signal to the transmitting inductor and inductively coupling the transmitting inductor and the receiving inductor so as to transmit the transmitting signal to the receiving inductor.
